(19) United States
(12) Patent Application Publication
(10) Pub. No.: US 2015/0176520 A1
(43) Pub. Date: Jun. 25, 2015

(54) SPARK PLUG

(71) Applicant: CATERPILLAR ENERGY SOLUTIONS GMBH, Mannheim (DE)

(72) Inventors: Olaf Berger, Dudenhofen (DE); Friedrich Schaefer, Edenkoben (DE)

(73) Assignee: CATERPILLAR ENERGY SOLUTIONS GMBH, Mannheim (DE)

(21) Appl. No.: 14/415,261

(22) PCT Filed: Jul. 11, 2013
(86) PCT No.: PCT/EP2013/002060

§ 371 Date: Jan. 16, 2015

(30) Foreign Application Priority Data
Jul. 25, 2012 (EP) 12177820.3

(51) Int. Cl. F02F 1/24; H01T 13/20

(52) U.S. Cl. CPC F02F 1/242; H01T 13/20

(57) ABSTRACT

A spark plug may include a shell surrounding a lower part of an insulator. The shell may be provided with a tool engaging portion, a seal face configured to contact a corresponding seal of a cylinder head of an internal combustion engine, a cylinder engaging threaded portion having a thread diameter (D) configured to screw the spark plug in a threaded bore of the cylinder head, and an intermediate portion extending between the shoulder and the cylinder engaging threaded portion. The intermediate portion may have a length (L₁), wherein: 0.20<=L₁/D<=0.80 and L₁ is the length and D is the thread diameter.

### TECHNICAL FIELD

The present disclosure refers in general to spark plugs configured to be used in internal combustion engines. Particularly, the present disclosure refers to spark plugs configured to be used in gas engines, for example internal combustion engines being operated by gaseous fuels, such as natural gas, shale gas, mine gas, biogas, landfill gas, sewage gas, and syngas. In addition, the present disclosure refers to spark plug bushings and cylinder heads, both configured to screw in spark plugs of the type described herein.

### BACKGROUND

The function of a spark plug is to introduce ignition energy into a combustion chamber and to initiate the combustion of an air-fuel mixture by electrical spark between its electrodes. For this reason a spark plug has to be operated with electronic ignition systems, voltages of up to 30,000 V or even higher may occur. The spark plug is positioned in the combustion chamber at the point most suitable for igniting the compressed air-fuel mixture. It must, under all operating conditions, introduce the ignition energy into the combustion chamber without developing a leak and without overheating. The spark plug must be designed to withstand operating conditions. The spark plug is exposed to both the periodic, cyclical variations within the combustion chamber and to the external climatic conditions. Consequently, spark plugs have to meet high mechanical demands and must resist chemical and thermal stress. That applies particularly to spark plugs to be used in gas engines.

For mounting a spark plug in a cylinder head a spark plug may have an external thread extending from a seal face of a shoulder or a captive outer gas kit disposed there to the end face of the spark plug where the cylindrical center electrode projects from the insulator nose. As spark plugs are exposed extreme high temperatures, but it is necessary that the spark plugs seats directly on a mating surface of the cylinder head, the seal between the spark plug and the cylinder head is by means of a flat seat or a conical seat. The flat seat version may use a captive gasket on the spark-plug shell as a sealing element. It might be specially shaped and provides a permanently elastic seal if correctly mounted. With the conical seat, without the use of a gasket, a conical surface of the spark shell seals directly on a mating surface of the cylinder head. This type of spark plug is shown, for example, in DE 2 022 685 A, U.S. Pat. No. 8,053,964 B2, U.S. Pat. No. 7,977,856 B2, U.S. Pat. No. 2,500,395, U.S. D 589,880 S, US 2010/0116039 A1, U.S. Pat. No. 3,313,972, U.S. Pat. No. 2,521,647, and U.S. Pat. No. 3,113,232.

A pre-chamber spark plug is shown in US 2007/0236122 A1.

US 2007/0126330 A1 shows a spark plug with an outer thread extending up to a shoulder of a metallic shell of the spark plug.

In DE 196 36 537 A1 a spark plug includes a cylindrical intermediate part having a diameter identical with the diameter of an external thread of the spark plug. The intermediate part is disposed between the seal face of gasket of the spark plug and the external thread. The cylindrical intermediate portion does not have an external thread. It shall increase the effective clamping length of the spark plug and, hence, it may reduce the risk that the spark plug becomes loose.

A spark plug similar to that of DE 196 36 537 A1 is shown in DE 2 022 685. Again, an intermediate or extension part extends between the external thread and the shoulder of the spark plug. Here, the intermediate part is used as an extending part and has no external thread. Contrary to the spark plug of DE 196 36 537 A1 the extension part of DE 2 022 685 has a diameter smaller than the external thread of the spark plug. The length of the intermediate or extension part of this spark plug is greater than the external diameter of the thread. The extension part shall result in that the supporting thread faces of the spark plug being disposed directly at the wall opening where the major part of the heat accumulates.

In US 2005/0284454 A1 an ignition device for an internal combustion engine having a spark plug is disclosed. The housing of the spark plug has a mounting portion to be disposed in a mounting hole provided in a cylinder head of the internal combustion engine. The mounting portion includes a screw portion and a non-screw portion. The screw portion is to be screw-fastened to the mounting hole. The non-screw portion is not to be screw-fastened to the mounting hole. The fasten portion has a length L. When the length L is 26.5 mm, a length b of the non-screw portion can be 16.5 mm at the maximum. When the length L of the fastened portion is not in accordance with the ISO standard, the length b of the non-screw portion will be 0<b≦(L−10).

Another housing for a spark plug is known from FR 2 091 351 or DE 2 022 685 A. Here, the spark plug comprises a connector, a center electrode connected to the connector, an insulator surrounding the center electrode and a shell surrounding a lower part of the insulator. A tool engaging portion is provided. A cylinder engaging threaded portion is configured to screw the spark plug in a threaded bore of the cylinder head. An intermediate portion extends between a shoulder and the cylinder-engaging threaded portion. At least one crowned electrode is disposed at an end of the cylinder-engaging threaded portion.

An internal combustion engine spark plug fitment is shown in GB 2 202 274 A. Here, the engine compression ratio shall be reduced by inserting an adapter into the normal spark plug opening in a combustion chamber wall. The adapter comprises an externally threaded tubular mounting portion which is screwed fully into the normal threaded opening in the wall and forms a chamber as an extension to the combustion chamber. A spark plug is screwed into an internal threaded bore of the adapter for its electrodes to be positioned within the extension chamber.

The present disclosure is directed, at least in part, to improving or overcoming one or more aspects of prior systems.

### SUMMARY OF THE DISCLOSURE

In a first aspect of the present disclosure a spark plug may comprise a connector, a center electrode connected to the connector, an insulator surrounding the center electrode, and a shell surrounding a lower part of the insulator. The shell may be provided with a tool engaging portion, a seal face configured to contact a corresponding seal face of a cylinder head, and a cylinder engaging threaded portion. The cylinder engaging threaded portion may have a thread diameter configured to screw the spark plug in a threaded bore of a cylinder head of an internal combustion engine. Alternatively, the spark plug may be screwed in a spark plug bushing, which is to be screwed in a cylinder head. An intermediate portion may extend between the seal face and the cylinder threaded portion. The intermediate portion may have a length L₁. In addition, the following relationship may be fulfilled: 0.20<=L₁/D<=0.80, wherein L₁ is the length of the intermediate portion and D is the thread diameter of the external thread of the spark plug. The spark plug may further comprise at least one ground electrode disposed at an end of the cylinder threaded portion.

In a further aspect of the present disclosure a cylinder head for an internal combustion engine may comprise at least one bore configured to receive an associated spark plug of the type disclosed herein. Each bore may have a first bore part provided with an inner wall and having a first inner diameter and a first length. A second bore part may be provided with an internal thread having an internal thread diameter and a second length, wherein: 0.20<=L₁/D<=0.8 and L₁ is the first length and D is the thread diameter.

In another aspect of the present disclosure a spark plug bushing may be configured to be inserted in a cylinder head of an internal combustion engine. The spark plug bushing may comprise a bushing body provided with an external thread configured to screw the spark plug bushing in a receiving bore of a cylinder head of an internal combustion engine. A stepped bore having a large diameter portion and a small diameter portion may be provided in the bushing. A seal face for contacting a mating seal face of a spark plug of the type disclosed herein may be formed between the large diameter portion and the small diameter portion. The small diameter portion may have a first bore part having a circumferential inner wall with a first diameter and a first length and a second bore part provided with an internal thread having a thread diameter and a second length, wherein: 0.20<=L₁/D<=0.8 and L₁ is the first length and D is the internal thread diameter.

Other features and aspects of this disclosure will be apparent from the following description and the accompanying drawings.

### BRIEF DESCRIPTION OF THE DRAWINGS

FIG. 1 shows a side view of the first exemplary embodiment of the spark plug according to the present disclosure;

FIG. 2 shows a second exemplary embodiment of the spark plug according to the present disclosure, such spark plugs are also known as chamber spark plugs;

FIG. 3 shows a sectional view of a part of a cylinder head of an internal combustion engine including a stepped bore configured to receive a spark plug of the type disclosed herein; and

FIG. 4 shows an exemplary embodiment of a spark plug bushing configured to receive a spark plug of the type disclosed herein and to be screwed in a cylinder head of an internal combustion engine.

### DETAILED DESCRIPTION

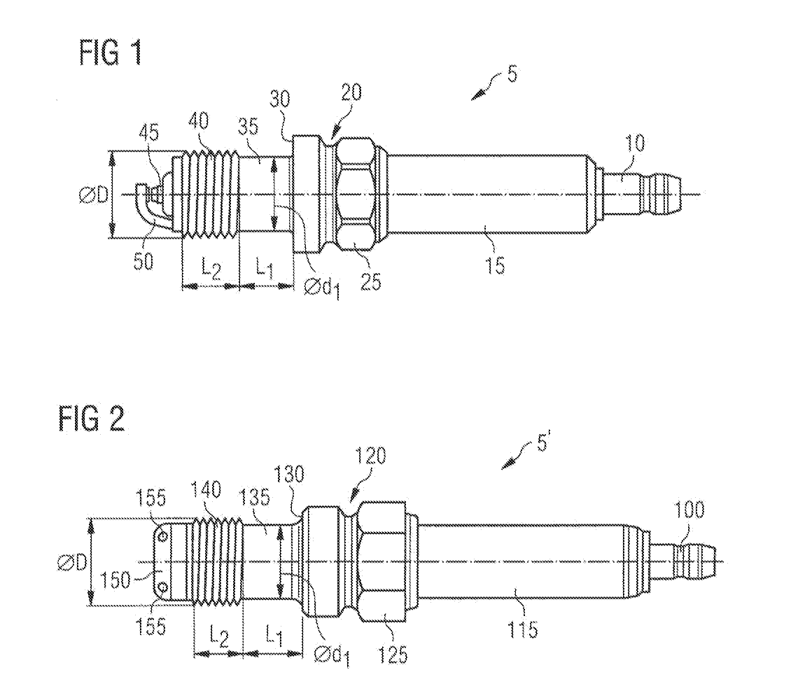

FIG. 1 shows a first exemplary embodiment of a spark plug 5 according to the present disclosure. The spark plug 5 may comprise a high-voltage connector 10 and a ceramic insulator 15. A metal shell 20 may surround a lower part of the insulator 15. The metal shell may have a hexagonal section 25 and may be formed with a seal face 30. The seal face 30 may be part of a shoulder of the shell 20. An external thread 40 having a length L₂ may be formed on an outer circumference of a lower part of shell 20. An intermediate part 35 may be disposed between the threaded portion 40 of shell 20 and seal face 30. The intermediate part 35 may have a length L₁ and a diameter d₁. The outer circumferential of the intermediate part may be formed without a thread.

The outer diameter d₁ of intermediate part 35 may be equal to or smaller than diameter D of external thread 40. As an alternative, the outer diameter d₁ of intermediate part 35 may be larger than diameter D of external thread 40. In case the outer diameter d₁ of intermediate part 35 is larger than diameter D of external thread 40, the strength of the spark plug may be increased. In addition, a possible drain of thermal heat from the spark plug to the cylinder head or a spark plug bushing may be increased.

A center electrode 45 may extend beyond threaded portion 40 and close to a ground electrode 50, also named L-electrode.

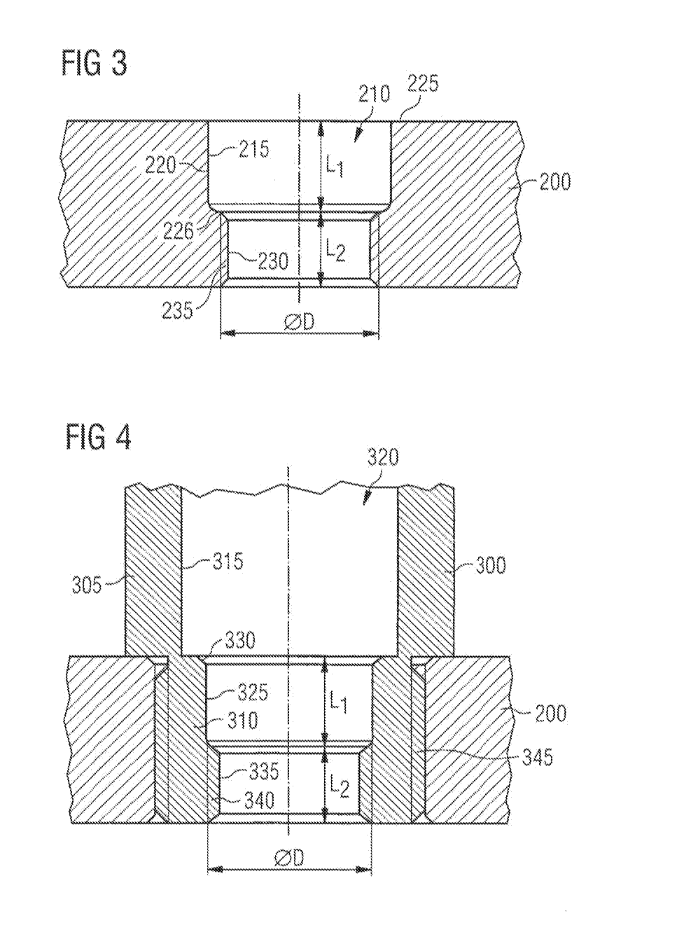

The spark plug 50 as shown in FIG. 1 may be designed such that the relationship length of the intermediate part 35, L₁, to the external diameter of the external thread, D, is greater than 0.20 and less than 0.80. In addition, d₁, i.e. the outer diameter of intermediate part 35, is equal to or less than the external diameter of external thread 40. Due to this design of spark plug 5, a higher and more steady pre-stress may be obtained if the spark plug 5 is screwed in a corresponding bore of a cylinder head 200 (see, for example, FIGS. 3 and 4). The intermediate part 35 may function as a relief groove between the seal face and the thread 45. Intermediate part 35 might form an elastic bridge between cylinder head engaging thread portion 40 and seal face 30. However, as mentioned above, alternatively the outer diameter d₁ of intermediate part 35 may be larger than diameter D of external thread 40.

In this respect, it has to be noted that a common gasket (not shown) may be placed on the seal face 30, if desired. Normally, gaskets may be used if seal faces 30 are flat. A gasket may be omitted if the seal face 30 is conically shaped.

Particularly, the length of the intermediate part 35 may be about 20% and 50% of the thread diameter D.

FIG. 2 shows a side view of a second exemplary embodiment of a spark plug 5′. This type of spark plug is also known as “chamber spark plug” or pre-chamber spark plug” (in German, “(Vor-)Kammerkerze”). Such chamber spark plugs may be available from the company MULTITORCH GmbH, Breite Seite 1 B, 74889 Sinsheim, Germany. The basic structure of the spark plug 5′ of FIG. 2 may be identical with that of the spark plug 5 of FIG. 1. Contrary to spark plug 5 of FIG. 1, spark plug 5′ of FIG. 2 has an end cap 150 forming a chamber around the center electrode (not shown) and ground electrode 50. The end cap 150 may comprise one or more holes 155. This type of spark plug 5′ may be adapted to be used particularly in internal combustion engines configured to burn gaseous fuels, such as natural gas, shale gas, mine gas, biogas, landfill gas, sewage gas, and syngas.

FIG. 3 shows a sectional view of a cylinder head 200 comprising at least one through hole 210 for receiving a spark plug 5, 5′ as disclosed herein. The through hole 210 may be formed as a stepped bore including an upper receiving bore part 220 and a lower receiving bore part 230. The upper receiving bore part and the lower receiving bore part 230 may be connected via a shoulder 226. A seat area 225 may be provided at the opening of through hole 210. Seat area 225 may be formed as a flat seat. Accordingly, a spark plug having a correspondingly formed seat may be inserted. Due to the fact that seat area 225 is flat, a gasket may be placed on seat area 225 and a spark plug to be screwed in the cylinder head 200.

The upper receiving bore part 220 may comprise an inner wall and it may have a length L₁. Lower receiving bore part 230 may be provided with an internal thread 235. The internal thread 235 and, correspondingly, the lower receiving bore part 230 may have a length L₂. The internal thread 235 may have a thread diameter D. Internal thread diameter D may be greater than 0.20 of length L₂ and less than 0.80 of length L₂. Consequently, spark plug receiving bore 210 may receive a spark plug 5, 5′ as shown, for example, in FIGS. 1 and 2. However, other spark plugs that that shown in FIGS. 1 and 2 may be screwed in the cylinder head 200 of FIG. 3.

A spark plug bushing 300 is shown in FIG. 4. A sectional view of an exemplary embodiment of the spark plug bushing 300 is shown. Here, spark plug bushing 300 is screwed in a corresponding threaded bore of a cylinder head 200.

The spark plug bushing 300 may comprise an upper bushing part 305 and a lower bushing part 310. Upper bushing part 305 may include a circumferential inner wall 315. An inner through bore 320 may include a stepped bore 325 formed in lower bushing part 310. The stepped bore 325 may be formed and shaped as a stepped bore 210 in the cylinder head 200 as shown in FIG. 3. Accordingly, a lower stepped bore part 235 may include an internal thread 340 having a thread diameter D. The spark plug bushing 300 may be formed with an external thread 345 at the lower bushing part 310. The external thread 345 may be used for screwing in the spark plug bushing 300 in a corresponding female thread bore in cylinder head 200 as shown in FIG. 4. Again, length L₁ of the upper bore part of stepped bore 325 may be greater than 0.20 of internal diameter D and less than 0.80 of internal diameter D.

Here, a conical seat 330 may be formed at the intersection of upper bushing part 305 and lower bushing part 310. Conical seat 330 may be contacted by a correspondingly formed seat area at a spark plug, for example a spark plug 5, 5′ as shown in FIGS. 1 and 2. Due to the conical seat 330 no gasket may be necessary.

The inner walls 215, 315 and 325 may have no thread formed thereon. Accordingly, these inner walls may be plain. Further, the outer circumferential walls of intermediate parts 35, 135 may be formed without a thread. Consequently, these walls may be plain.

### INDUSTRIAL APPLICABILITY

A spark plug 5 or a spark plug 5′ as shown in FIGS. 1 and 2, respectively, may be screwed in a spark plug receiving bore 210 of cylinder head 200 as shown in FIG. 3. In an operating position, spark plug 5 or spark plug 5′ may seal with shoulder 225 of the spark plug through bore 210. However, it is also possible that a gasket (not shown) is disposed between the spark plug 5, 5′ and shoulder 225. If spark plug 5, 5′ is tightened correctly, the spark plug 5, 5′ seals the combustion chamber (i.e. space “below” cylinder head 200 shown in FIG. 3) from the space shown above cylinder head 200 of FIG. 3.

As a result of the unique design of spark plugs 5, 5′ and the corresponding spark plug receiving bore 210 in cylinder head 200, less thermal stress and less mechanical stress may be achieved.

A spark plug bushing 300 as shown in FIG. 4 may be screwed in the corresponding receiving bore in cylinder head 200. Then, a spark plug 5, 5′ as shown in FIGS. 1 and 2, respectively, may be screwed in spark plug bushing 300. Again, the same results may be achieved as in the case where spark plugs 5, 5′ are screwed in cylinder head 200 directly.

The term “lower part” as used herein may define a part or section of a spark plug disposed closer to an associated combustion chamber than a part or section of the spark plug disposed closer to the connector of the spark plug if the spark plug is in use in an internal combustion chamber. The term “lower part” as used herein shall not be interpreted in a more limited sense than explained above.

The term “seal face” may define a defined area of a spark plug formed to be mated with a corresponding area of a cylinder head or a spark plug bushing. It has to be noted that even if a gasket may be interposed between two mating areas the term “to be mated” may be used. The same applies to seal faces or areas of a cylinder head and a spark plug bushing.

The term “thread diameter” may mean that diameter of a corresponding technical regulation, such as DIN, used to define thread diameters of spark plugs, bore holes in cylinder heads and spark plug bushings. Spark plugs as disclosed herein may have a thread diameter within a range of M18×1.5 and M30×2.0, wherein M18 . . . M30 is the diameter of the external thread of the spark plug and the number after “×” is the pitch of the thread. Alternatively, threads of ⅝ and ⅞ may also be used. All these thread sizes may also be used for cylinder heads and spark plug bushings as disclosed herein.

Although the preferred embodiments of this invention have been described herein, improvements and modifications may be incorporated without departing from the scope of the following claims.

1. A spark plug, comprising:
a connector;
a center electrode connected to the connector;
an insulator surrounding the center electrode;
a shell surrounding a lower part of the insulator, the shell being provided with a tool engaging portion, a seal face configured to contact a corresponding seal of a cylinder head of an internal combustion engine, a cylinder engaging threaded portion having a thread diameter (D) configured to screw the spark plug in a threaded bore of the cylinder head, and an intermediate portion extending between the seal face and the cylinder engaging threaded portion, wherein the intermediate portion has a length (L₁), wherein: 0.20<=L₁/D<=0.80 and L₁ is the length and D is the thread diameter; and
at least one ground electrode disposed at an end of the cylinder engaging threaded portion.

2. The spark plug of claim 1, wherein: 0.20<=L₁/D<=0.50 and L₁ is the length and D is the thread diameter.

3. The spark plug of claim 1, the intermediate portion having an outer diameter (d) equal to or smaller than the external diameter (D) of the cylinder engaging threaded portion.

4. The spark plug of claim 1, the intermediate portion having an outer diameter (d) greater than the external diameter (D) of the cylinder engaging threaded portion.

5. The spark plug of claim 1, wherein the spark plug is designed as a chamber spark plug.

6. The spark plug of claim 1, wherein the thread diameter is within a range between M14 and M30.

7. A cylinder head of an internal combustion engine, comprising:
at least one bore configured to receive an associated spark plug;
wherein each bore has a first bore part provided with an inner wall and a first inner diameter (d1) and a first length (L₁), and a second bore part provided with an internal thread having a thread diameter (D), wherein: 0.20<=L₁/D<=0.80 and L₁ is the first length and D is the thread diameter.

8. The cylinder head of claim 7, wherein: 0.20<=L₁/D<=0.50 and L₁ is the first length and D is the thread diameter.

9. The cylinder head of claim 7, wherein the thread diameter is within a range between M14 and M30.

10. A spark plug bushing configured to be inserted in a cylinder head of an internal combustion engine, the spark plug bushing comprising:
a bushing body having an external thread configured to screw the spark plug bushing in a receiving bore of the cylinder head, and a stepped bore having a large diameter portion and a small diameter portion, wherein a seat shoulder for contacting a corresponding seal face of a spark plug is formed between the large diameter portion and the small diameter portion;
the small diameter portion having a first bore part with a first diameter (d1) and a first length (L₁) and a second bore part provided with an internal thread having a thread diameter (D) and a second length (L2), wherein: 0.20<=L₁/D<=0.80 and L₁ is the first length and D is the thread diameter.

11. The spark plug bushing of claim 10, wherein: 0.20<=L₁/D<=0.50 and L₁ is the first length and D is the thread diameter.

12. The spark plug bushing of claim 10, wherein the thread diameter is within a range between M14 and M30.

13. The spark plug of claim 2, the intermediate portion having an outer diameter (d) equal to or smaller than the external diameter (D) of the cylinder engaging threaded portion.

14. The spark plug of claim 2, the intermediate portion having an outer diameter (d) greater than the external diameter (D) of the cylinder engaging threaded portion.

15. The spark plug of claim 6, wherein the thread has a size that is one of M14×1.25, M18×1.5, M22×1.5, M30×1.75, or M30×2.0.

16. The cylinder head of claim 9, wherein the thread has a size that is one of M14×1.25, M18×1.5, M22×1.5, M30×1.75 or M30×2.0.

17. The spark plug bushing of claim 12, wherein the thread has a size that is one of M14×1.25, M18×1.5, M22×1.5, M30×1.75 or M30×2.0.

18. The spark plug of claim 2, wherein the spark plug is designed as a chamber spark plug, the chamber spark plug including an end cap forming a chamber around the center electrode and the at least one ground electrode.

19. The spark plug of claim 3, wherein the spark plug is designed as a chamber spark plug, the chamber spark plug including an end cap forming a chamber around the center electrode and the at least one ground electrode.

20. The spark plug of claim 4, wherein the spark plug is designed as a chamber spark plug, the chamber spark plug including an end cap forming a chamber around the center electrode and the at least one ground electrode.
